(19) United States
(12) Patent Application Publication
(10) Pub. No.: US 2008/0065503 A1
(43) Pub. Date: Mar. 13, 2008

(54) METHOD FOR ON SITE CUSTOM BUILD OF YOUR OWN COMPUTER

(75) Inventor: Alex J. Cook, Bentonville, AR (US)

Correspondence Address: BLACKWELL SANDERS LLP, 720 OLIVE STREET, SUITE 2400, ST. LOUIS, MO, 63101, US

(73) Assignee: WAL-MART STORES, INC., Bentonville, AR (US)

(21) Appl. No.: 11/530,819

(22) Filed: Sep. 11, 2006

(51) Int. Cl. G06Q 30/00

(52) U.S. Cl. 705/26

(57) ABSTRACT

An in-store method for allowing a consumer to order and have assembled a custom computer such as for example a notebook computer, and for the quick and easy assembly of said notebook computer on-site through modular, and coded components. Each notebook can begin as a simple chassis, which can be populated by core components, such as a panel, keyboard, mouse, motherboard, video card, speakers, a wireless LAN interface (such as a wireless card), and external ports (such as USB, VGA, RJ-45, etc.). The modular components can be standardized and can be functional in the computer system with whichever selectable components are chosen by the consumer. The present invention not only increases the speed and ease of assembly, but also allows for much easier upgrading of components at a later date

### BACKGROUND

1. Background of Invention

This invention relates generally to a method for custom ordering computing devices and, more particularly, to the custom ordering and on-site assembly of modular computing components in a retail environment.

2. Background Art

There are various methods for ordering and purchasing computers, where the buyer has the ability to select from among a laundry list of computing components having various levels of capability, such as for example, selecting a 50 GB hard drive, a 80 GB hard drive or a 250 GB hard drive. In general, there are two dominate methods of buying a computer. The first is to go to a brick-and-mortar store that sells computers, and purchase one onsite. There are usually various off the shelf models available each having varying capability and features. However, there are some electronic stores that specialize in computers that offer some additional flexibility where a consumer can select a base model or category and customize slightly by having certain options for some components such as for example selecting more or less memory or a larger or smaller hard drives within certain limitations for a given model or category. The second method is to order a computer in a similar manner in an online environment.

When going to a brick-and-mortar location, there are typically a plurality of available configurations and brands from which to select. Most or all of these configurations are on display and may actually be available for in-store testing/use. This ability to physically go to a store and select, after hands-on use, a particular model has made in-store purchasing the preferred method of some buyers. Not only do consumers get a chance to touch, feel and try the system before they buy it, also there is often a much more secure feeling when purchasing from a well known location where there is interaction with a knowledgeable sales staff. This coupled with the ability to select a system and walk out of the store with the computer only a few minutes later is of great convenience to some people.

However, some consumers prefer the convenience of going online to that of going to a brick-and-mortar location. Consumers can go online to websites operated by major computer manufacturers, such as Dell, Sony, and Gateway, and select nearly the exact system that they want. Typically, a user selects from general categories or models entailing a low performance/low cost system, a high performance/high cost system, and an average performance/average cost system, and usually within a selected category the user can usually select from among several options of various components where within a component category there may be various levels of performance and cost. Such as, for example, multiple levels of processors may be the defining feature of a given general category. After selecting as many of their desired components as the website allows, the consumer pays for the system, and then waits at home while the system is assembled and delivered—sometimes several weeks later.

Occasionally, the systems built by online retailers have some modular components. A few notebook chassis have one or two non-dedicated bays into which several different pieces can fit—an extra battery, or an optical drive, perhaps. And a few notebooks have contained other modular pieces—modular keypads, for example.

All of these systems have their problems. When going to a brick-and-mortar location, there is typically limited flexibility of system design. The only systems that can be bought are the systems or models on hand or which the retail store particularly carries, and no others. There is limited ability to further customize options within a model or category. Similarly, when buying a computer from an online retailer, there is still a lack of complete freedom to configure a system. Some notebook chassis do not support certain components, such as a high end notebook not supporting a slower processor, or vice versa. Also, the wait time for online purchases—sometimes up to several weeks—is unacceptable to some. These factors, combined with the lack of security that comes from buying in a store with helpful staff, have dissuaded many consumers from buying online.

There has yet to be a truly modular system in which the processor itself was a modular component. Typically, certain motherboards will support certain processors, but not others. It can be quite difficult to design a complete system that can be operated with any of several different processors. Processors are typically not considered a “plug-and-play” component—that is, they require processor specific hardware.

Accordingly, a need remains for an improved method for selling and building notebook computers. The present invention satisfies such a need by providing for in-store, on-site designing, assembly, and buying of modular notebook computers. The present invention will greatly increase the flexibility of in-store buying, while providing a much faster delivery of the product—typically about approximately one hour.

### BRIEF SUMMARY OF THE INVENTION

The invention is an in-store method for allowing a consumer to order and have assembled a custom computer such as for example a notebook computer, and for the quick and easy assembly of said notebook computer on-site through modular, and coded components. Notebook computers will be used as an example throughout but the scope of the invention is not limited to the notebook computer example. Each notebook can begin as a simple chassis, which will be populated by core components, such as a panel, keyboard, mouse, motherboard, video card, speakers, a wireless LAN interface (such as a wireless card), and external ports (such as USB, VGA, RJ-45, etc.). These are all standardized, modular components that will be functional in the computer system with whichever selectable components are chosen by the consumer. The present invention not only increases the speed and ease of assembly, but also allows for much easier upgrading of components at a later date.

The consumer, upon entering the store, will be able to browse through a plurality of different configurations, just as in a typical computer store. After a “hands on” experience with some variously configured computers having therein some of the available components, the consumer can select from a list containing general categories of computing components including, but not limited to multiple grades of processor speeds, RAM sizes, optical drives, hard drive speeds/sizes (which are preloaded with all needed software that is compatible with any hardware configuration that the buyer ultimately selects), and batteries, all of which vary by performance capability. After the consumer has made selections from each category, possibly through an order form or entry into a terminal, the information may be entered into a computer system. The consumer pays for the system, and the population and assembly of the chassis with the specific grade components selected by the consumer can be performed. Each component fits directly into a predefined location in the chassis, no matter that component's individual specification or capability level, for example, a 50 GB hard drive fits in the same location as a 150 GB hard drive, and is possibly color coded for easier assembly. For example, all processors fit into the same motherboard, all hard drives fit into the same bay, all RAM is designed so as to fit into the same slot, etc. Alternatively, various motherboard configurations can be made available and categorized based on what processor is chosen by the consumer. For example, selection of processor “A” can necessitate corresponding motherboard “A”.

Once the notebook is assembled, after the consumer has ordered it, it is tested on-site. After it has passed all required tests, the computer is delivered to the consumer in the store, and the consumer can walk out of the store with a custom built notebook assured in the fact that the purchase was made after hands-on testing, and after consulting with a well informed salesperson.

### BRIEF DESCRIPTION OF THE DRAWINGS

For a better understanding of the present invention, reference may be made to the accompanying drawings in which:

FIG. 1 is a block diagram of a typical notebook computer according to an embodiment of the invention;

FIG. 2 is a flow chart illustrating the operation of an embodiment of the invention;

FIG. 3 is a diagram of a store's typical notebook design and ordering section layout, as well as the notebook assembly area layout; and

FIG. 4 is a flow chart illustrating the operation of an automatic system configuration process.

### DETAILED DESCRIPTION OF THE INVENTION

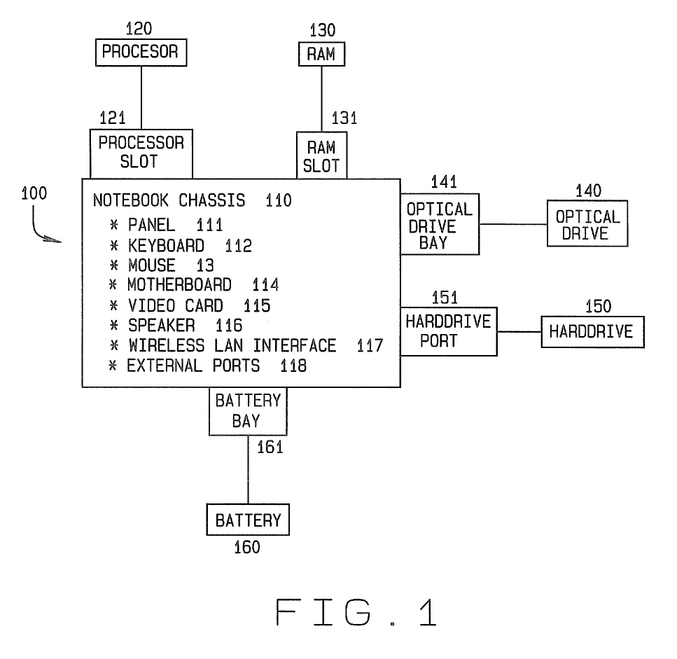

According to the embodiment(s) of the present invention, various views are illustrated in FIG. 1-3 and like reference numerals are being used consistently throughout to refer to like and corresponding parts of the invention for all the various views and figures of the drawing. Also, please note that the first digit(s) of the reference number for a given item or part of the invention should correspond to the Fig. number in which the item or part is first identified.

One embodiment of the present invention comprising the selection of modular, color coded components and a stock chassis or “shell” containing several universal components, and the assembly, testing, and final purchase of the components and chassis as a functioning computer teaches a novel method for an on-site custom order and assembly sales center. Herein by way of example a notebook computer (laptop computer) is discussed however the present invention can be utilized for any computing device including a desktop personal computer (PC) and personal data assistant (PDA).

The details of the invention and various embodiments can be better understood by referring to the figures of the drawings. Referring to FIG. 1, a block diagram of modular notebook computer 100 is shown. Each notebook computer begins with a notebook chassis 110 that contains only universal components that are non-customizable and are included with that chassis 100, and further including a panel 111, a keyboard 112, a mouse 113, a motherboard 114, a video card 115, speakers 116, wireless LAN capability 117, and external ports 118 such as USB, VGA, RJ-45, etc. These notebook chassis may be available in several general categories where each general category of chassis is populated by universal core components with specific performance/cost levels, but all configurations will be compatible with all selectable component options.

The selectable components can include the processor 120, RAM 130, optical drive/writer 140, hard drive 150, optional secondary media drive/writer or reader and battery 160. The hard drive 150 can be preloaded with all needed software 152, all of which can be compatible with any component and chassis configuration that could be selected. Any processor 120 selection, RAM 130 selection, optical drive 140 selection, hard drive 150 selection, and battery 160 selection will fit easily into the provided processor slot 121 on the motherboard, RAM slot 131, optical drive bay 141, hard drive port 151, and battery bay 161, respectively. The slots and components can be color coded for ease of assembly. For example, processor slots can be color coded to correspond to like color code processors that it is capable of accepting.

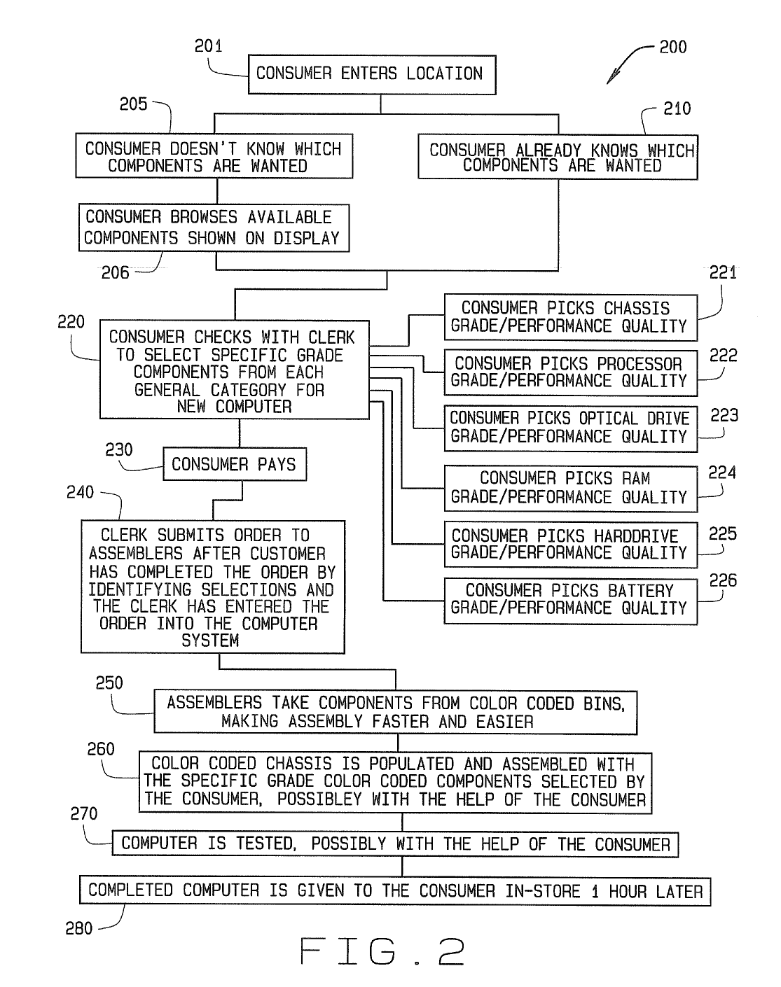

Referring to FIG. 2, a process flow chart of one embodiment of the notebook custom selection assembly and purchase method 200 is shown. First, the consumer enters the store or notebook section of the store, 201. Here, if the consumer does not already have an idea of which components to select 205, the consumer can browse available notebook builds displayed around the store or store section to decide which components to select 206, after which the consumer proceeds to consult with a clerk to order components for a new notebook 220. However, if the consumer already knows which components are desired 210, the consumer can bypass the step of browsing the available components 206 and proceed directly to the consultation with the clerk regarding the ordering of the desired notebook chassis and components 220.

Selecting the desired components 220 includes the steps of selecting a chassis 221, selecting a processor 222, selecting an optical drive 223 or other media drive, selecting the RAM 224, selecting the hard drive 225, and selecting the battery 226, and can be completed in any order. These are considered general category components. A specific grade component can be for example a 1 G Byte SRAM or a 250G8 hard drive.

Within each general category of components there can be multiple options from which to select. For example, in the general category of optical drives the buyer can have the option of selecting between a DVD/CD read only combo drive or a DVD/CD read and write combo drive. Also, some general categories may be optional such as for example a secondary media drive or reader. The buyer can optionally complete a check list form or complete a checklist on a consumer interface terminal for selecting items where each item has an optional color coding and/or configuration ID associated thereto. Also this step may be optionally input into a computing system through a user interface where the computer system is operable to track the order. The consumer has selected all of the components and the shell that will comprise the new computer, the consumer can pay for the computer 230. The clerk then submits the order to the assemblers 240 either manually or by way of some computing system or network, who are located in a special assembly section of the store. There, the assemblers collect the selected components, which are possibly color coded, from storage bins 250 that are possibly color coded. The assemblers then connect/install all of the selected components to the possibly color coded appropriate slots/bays of the desired chassis 260, which would make the assembly process fast, easy, and reliable. Then, the product is tested 270 in a special testing area. After the assembled notebook has been tested, it is given to the consumer to take home 280 about an hour after the order was placed.

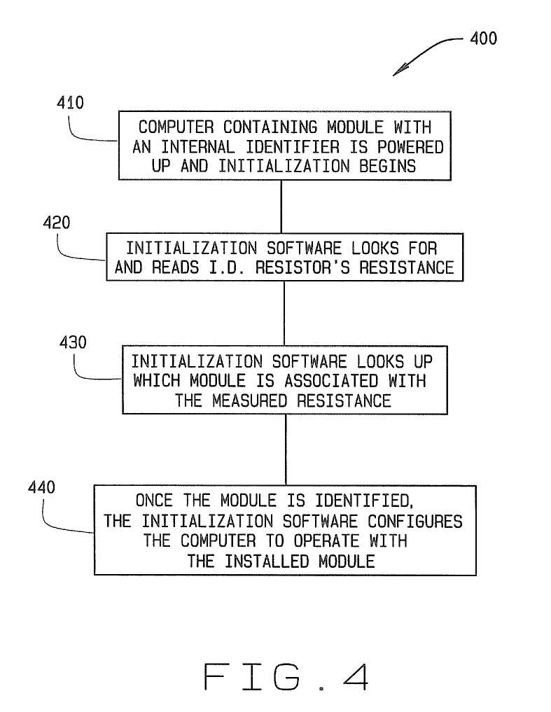

Referring to FIG. 4, when the computer is assembled and tested, the system can be designed to have stored thereon a startup routine that automatically configures the system 400. This can be accomplished through an internal coding or internal identifier for each component, which alerts the system to the component's type (i.e. hard drive, RAM, etc.) as well as the components particular specifications (i.e. hard drive speed/storage capacity, amount of RAM, etc.) on start-up 410. Once the system has been alerted to the presence 420 and specifications of each of the components 430, the required setup software is accessed allowing the computer to automatically self-configure 440. For example, in one embodiment, each module can have a unique configuration identifier, such as an I.D. resistor 410. At startup, initialization software can read and associate the I.D. resistor 420 in that module with the module's type and specifications 430. To accomplish this, a look-up table can be stored and accessed by the computer's initialization software such that all I.D. resistors can be looked up and associated with the associated modules that are accessed at startup.

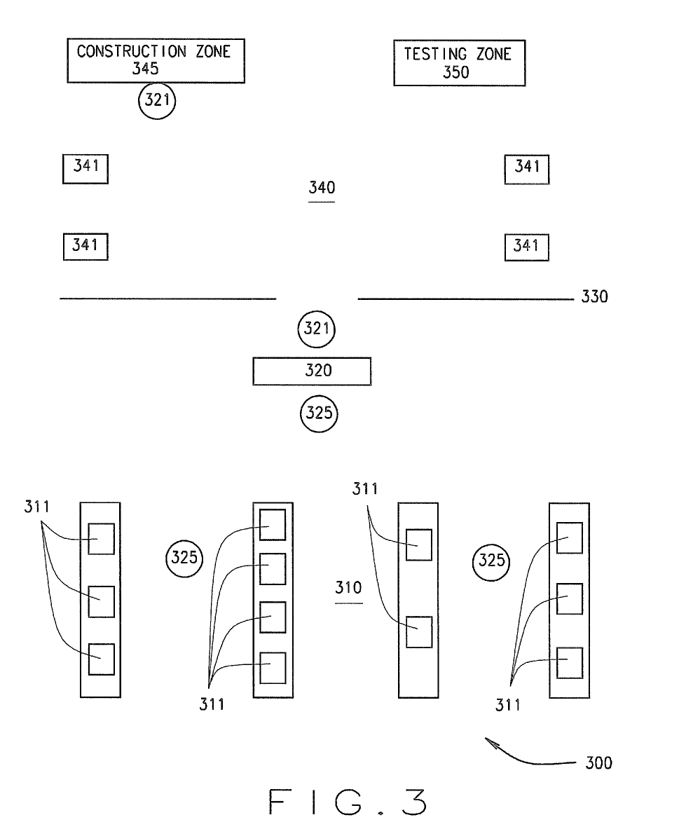

Referring to FIG. 3, one embodiment of a store or store section of the in-store custom selection, build, and test area is shown 300. The consumer 325 can first spend time in the component/notebook build display area 310 in which completed and operational computers 311 are available for testing/use so that the consumer 325 may decide which components are desired. The consumer can then proceed to the component selection and payment area 320 where a clerk 321 waits to take the consumer's order, submit the order to the assemblers, and take the consumer's 325 payment. These areas 310 and 320 can be separated from the notebook assembly 340 and notebook testing 350 areas by a partition 330 that hides the assembly and testing parts of the process from the consumer 325. However, the partition 330 does not have to be there, and the entire process could be in view of the consumer. Also, as an option the consumer can participate in the assembly and testing process.

The notebook assembly/testing area 340 can contain bins 341 which are possibly color coded, said bins containing components which are possibly color coded as well in like manner, making assembly fast, easy, and reliable. The assemblers, after taking the ordered components from the bins 341, assemble the notebook at the notebook construction zone 345, which could consists of tables and benches for workspace. The completed notebook is then taken to the testing area 350 where all of the components are tested and where the computer system will be powered up, initialized, and configured for the first time. The completed and tested notebook would then be given to the waiting consumer 325 at the component selection and payment area 320.

The various in-store build-your-own notebook method embodiments shown above illustrate a novel notebook ordering process. A user of the present invention may choose any of the above embodiments, or an equivalent thereof, depending on the desired process. In this regard, it is recognized that various forms of the subject in-store build-your-own notebook computer process could be utilized without departing from the spirit and scope of the present invention.

As is evidence from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention.

Other aspects, objects, and advantages of the present invention can be obtained from a stuffy of the drawings, the disclosure and the appended claims.

What is claimed is:

1. A method for custom selecting components of a computing system comprising the steps of:
providing in a retail environment a chassis for a computing device where said chassis is populated with core components;
providing in said retail environment general categories of computing components, where each general category comprises multiple specific grade components from which a consumer can select;
selecting by the consumer specific grade components for each general category;
further populating and assembling chassis with the specific grade components selected by the consumer creating an assembled computer;
testing in said retail environment the assembled computer; and
delivering said assembled and tested computer to the consumer in said retail environment.

2. The method for custom selecting components of a computing system as recited in claim 1, where the step of providing in a retail environment a chassis includes providing general categories of chassis from which the consumer can select, and where each general category of chassis is populated with a specific grade of core components.

3. The method for custom selecting components of a computing system as recited in claim 2, where the general categories of chassis vary in performance capability.

4. The method for custom selecting components of a computing system as recited in claim 1, where said core components further comprises,
a panel, a keyboard, a mouse, a motherboard, a video card, a speaker, a wireless LAN interface, and external ports.

5. The method for custom selecting components of a computing system as recited in claim 1, where the general categories of computing components further comprise configuration identifiers.

6. The method for custom selecting components of a computing system as recited in claim 5, where the configuration identifiers are I.D. resistors.

7. The method for custom selecting components of a computing system as recited in claim 1, where the general categories of computing components each have a component color code where each component color code corresponds to a color code of a bay/slot in which each computing component is installed.

8. The method for custom selecting components of a computing system as recited in claim 1, where said general categories of computing components further comprises,
Processors, RAM, Hard Drives, Optical Drives, and Batteries.

9. The method for custom selecting components of a computing system as recited in claim 1, where the multiple specific grade components vary by performance capability.

10. The method for custom selecting components of a computing system as recited in claim 1, further comprising the step of:
completing an order form identifying the consumer's selection.

11. The method for custom selecting components of a computing system as recited in claim 1, further comprising the step of:
entering the consumer's order into a computer system.

12. The method for custom selecting components of a computing system as recited in claim 1, where the step of populating and assembling the chassis with the specific grade components selected by the consumer includes allowing the consumer to be involved in the assembly process.

13. The method for custom selecting components of a computing system as recited in claim 1, where the step of testing the assembled computer includes allowing the consumer to be involved in the testing process.

14. The method for custom selecting components of a computing system as recited in claim 1, where the step of selecting specific grade components by the consumer occurs in a separate area from an assembly/testing area for the computers.

15. The method for custom selecting components of a computing system as recited in claim 14, where the area for assembly/testing is not visible from the area in which consumers select their components.

16. The method for custom selecting components of a computing system as recited in claim 14, where the area for assembly/testing is visible to the area in which consumers select their components.

17. The method for custom selecting components of a computing system as recited in claim 14, where the assembly/testing area further comprises:
sorting bins containing components.

18. The method for custom selecting components of a computing system as recited in claim 1, where the step of testing the assembled computer further comprises the step of:
powering up the computer and initializing a self configuration process.
